(19) United States
(12) Patent Application Publication
(10) Pub. No.: US 2017/0060825 A1
(43) Pub. Date: Mar. 2, 2017

(54) INFORMATION PROCESSING METHOD AND INFORMATION PROCESSING APPARATUS

(71) Applicants: BEIJING KUANGSHI TECHNOLOGY CO., LTD., Beijing (CN); PINHOLE (BEIJING) TECHNOLOGY CO., LTD., Beijing (CN)

(72) Inventors: Yuning JIANG, Beijing (CN); Qi YIN, Beijing (CN)

(21) Appl. No.: 14/983,161

(22) Filed: Dec. 29, 2015

(30) Foreign Application Priority Data
Aug. 24, 2015 (CN) 201510524129.7

(51) Int. Cl. G06F 17/22; G06Q 30/02; G06F 17/27; G06T 11/60; G06F 17/21; G06T 7/00

(52) U.S. Cl. CPC G06F 17/2247; G06F 17/2252; G06F 17/211; G06T 7/0081; G06F 17/27; G06T 11/60; G06Q 30/0277

(57) ABSTRACT

An information processing method and an information processing apparatus are provided, the method comprising: acquiring an original web page; resolving the original web page to determine a target image; analyzing at least one of the target image and context associated with the target image, to obtain a content feature of the original web page; determining display content matched with the content feature based on the content feature; inserting the display content into a target region corresponding to the target image, of the original web page, to obtain a target web page; and outputting the target web page.

### TECHNICAL FIELD OF THE DISCLOSURE

The present disclosure relates to the information processing field, and particularly to an information processing method and an information processing apparatus.

### BACKGROUND

With the development of Internet technology, a technology occurs in which additional information is inserted into a web page browsed by a user. In such technology, it is desired that the inserted information is interesting to the user, and the display of the inserted information is significant without affecting the user's normal browsing experience.

Taking the Internet advertisement as an example, in the current advertising method for an Internet presentation advertisement, a user's point of interest is determined by analyzing the user's past actions, such as the user's browsing records, and the advertisement matched with the user's point of interest is inserted into the web page being browsed by the user. However, in such advertising method, first, since the user's current point of interest is analyzed based on the user's past actions and the user's point of interest may be changed at any time, a deviation may occur in such interest mining, resulting in a lowered accuracy for the advertising. Next, the advertisement is either inserted into a significant region of a main body part of the web page or into an insignificant region of the web page. In the former case, the user's browsing experience is largely affected and the user's experience is decreased. In the latter case, the advertisement is often neglected by the user, resulting in a poor advertising effect. Further, in either case, the display of the advertisement is not matched with the display of the browsed web page, so that it is abrupt and not artistic, thereby the user experience is also decreased.

### SUMMARY

In view of the above, the present disclosure provides an information processing method and an information processing apparatus, which enables to insert information matched with content of a current web page into a web page notably without affecting the user's browsing experience.

According to an embodiment of the present disclosure, an information processing method is provided, comprising: acquiring an original web page; resolving the original web page to determine a target image; analyzing at least one of the target image and context associated with the target image, to obtain a content feature of the original web page; determining display content matched with the content feature based on the content feature; inserting the display content into a target region corresponding to the target image, of the original web page, to obtain a target web page; and outputting the target web page.

According to another embodiment of the present disclosure, an information processing apparatus is provided, comprising: an acquiring unit operative to acquire an original web page; a resolving unit operative to resolve the original web page to determine a target image; an analyzing unit operative to analyze at least one of the target image and context associated with the target image, to obtain a content feature of the original web page; a determining unit operative to determine display content matched with the content feature based on the content feature; an inserting unit operative to insert the display content into a target region corresponding to the target image, of the original web page, to obtain a target web page; and an output unit operative to output the target web page.

According to a further embodiment of the present disclosure, an information processing apparatus is provided, comprising: a processor; a memory; computer program instructions stored in the memory, which, when executed by the processor, perform steps of: acquiring an original web page; resolving the original web page to determine a target image; analyzing at least one of the target image and context associated with the target image, to obtain a content feature of the original web page; determining display content matched with the content feature based on the content feature; inserting the display content into a target region corresponding to the target image, of the original web page, to obtain a target web page; and outputting the target web page.

According to a further aspect of the present disclosure, a computer program product is provided, comprising a computer readable storage medium having stored thereon computer program instructions, which, when executed by a computer, perform steps of: acquiring an original web page; resolving the original web page to determine a target image; analyzing at least one of the target image and context associated with the target image, to obtain a content feature of the original web page; determining display content matched with the content feature based on the content feature; inserting the display content into a target region corresponding to the target image, of the original web page, to obtain a target web page; and outputting the target web page.

In the information processing method and the information processing apparatus according to the embodiments of the present disclosure, at least one of an image and a context in a web page is analyzed to obtain a content feature of the web page, and display content matched with the content feature is inserted into a target region of the web page, so that the information matched with the content feature of the current web page is inserted into the web page notably without affecting the user's browsing experience.

### BRIEF DESCRIPTION OF THE DRAWINGS

FIG. 1 is a flowchart showing steps of an information processing method according to an embodiment of the present disclosure;

FIGS. 2A-2D are schematic diagrams showing a scenario to which the information processing method according to an embodiment of the present disclosure is applied;

FIG. 3 is a block diagram showing a main configuration of an information processing apparatus according to an embodiment of the present disclosure; and

FIG. 4 is a block diagram showing a main configuration of an information processing apparatus according to another embodiment of the present disclosure.

### DETAILED DESCRIPTION

Hereinafter, the embodiments of the present disclosure will be described in detail with reference to the accompany drawings.

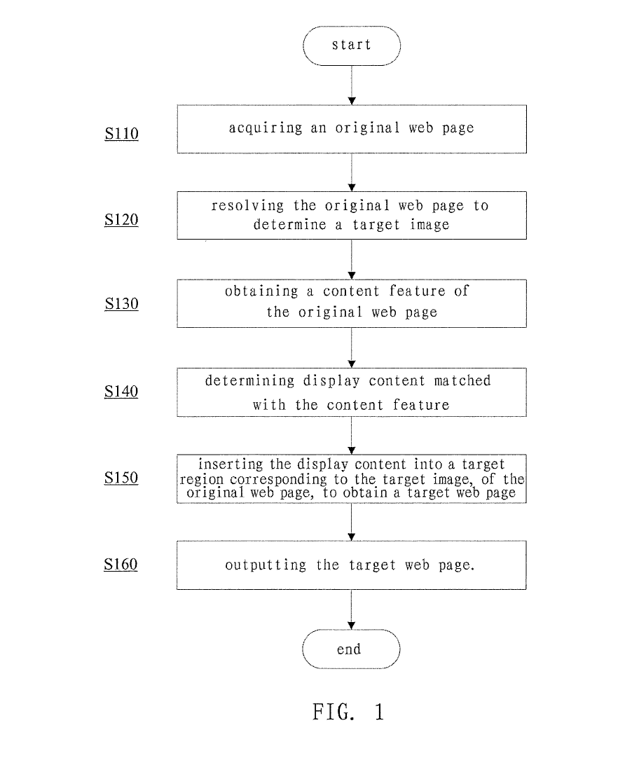

First, the information processing method according to an embodiment of the present disclosure will be described with reference to FIG. 1.

As shown in FIG. 1, first, at a step S110, an original web page is acquired.

Particularly, an address of a web page, which is referred to as the original web page hereinafter when appropriate for distinction, is acquired according to an access request from a user, when the user accesses to the web page.

Next, at a step S120, the original web page is resolved to determine a target image.

Particularly, code of the original web page may be resolved to acquire image information of each image in the original web page. The image information represents an attribute of the image, which includes, but not limited to, at least one of the size of the image, the location of the image, the significance of the image or the like, and any combination thereof.

Then, the target image may be determined from all images in the original web page, based on the image information.

Particularly, for example, the selecting criteria of the target image may be determined. In a first example, the selecting criteria may be that the size of the image is larger than a predetermined size threshold. In a second example, the selecting criteria may be that the location of the image is within a predetermined range. In a third example, the selecting criteria may be that the significance of the image is larger than a predetermined significance threshold. The predetermined size threshold, the predetermined range and the predetermined significance threshold may be set properly by those skilled in the art when necessary, and are not limited here. Further, the above are only examples, and those skilled in the art may design various selecting criterion according to corresponding image information.

Thereby, it may be determined whether the image information of each image satisfies the selecting criteria, and one or more images satisfying the selecting criteria may be determined as the target image.

Then, at a step S130, at least one of the target image and context associated with the target image is analyzed, to obtain a content feature of the original web page.

The content feature includes at least one of an image content feature and a context content feature. Particularly, on one hand, an image recognition process may be performed on the target image to obtain the image content feature. More particularly, the image recognition process may be performed on the target image in various recognition ways, such as a face recognition, a text recognition, an object recognition, a scenario recognition or the like, to obtain corresponding image content feature. For example, it may be detected whether the target image includes a face through the face recognition. It may be detected whether the target includes text (and the content of the text), for example, a book, a brand of a shop or the like, through the text recognition. It may be detected whether the target image includes a specific object, such as a vehicle, a bicycle, a house or the like, through the object recognition. It may be detected whether the target image corresponds to a specific scenario, such as indoor, forest, beach or the like, through the scenario recognition. After obtaining the corresponding recognition result through the recognition as described above, the target image may be attached with a corresponding tab, such as FACE, or the like. The particular processes of the image recognition are known to those skilled in the art and will not be described here in detail.

On the other hand, a natural language process may be performed on the context associated with the target image to obtain the context content feature.

More particularly, the context is associated with the target image. In an example, a distance between the context and the target image is smaller than a predefined distance. For example, the text is a word, a sentence, a paragraph or the like immediately above or below the target image. In another example, the context is a sentence, a paragraph or the like including a predetermined keyword. The predetermined keyword is, for example, the below figure, the above figure, or the like. Of course, those skilled in the art may design various other association ways between the context and the target image, which will not be described here in detail.

Thereby, the context content feature may be analyzed by various methods such as the natural language process or the like. More particularly, the adopted natural language process method may be, such as a word vector based method, a deep learning based method, or the like, the detailed processes of which are known to those skilled in the art and will not be described here in detail.

After obtaining the content feature of at least one of the context content feature and the image content feature, the information processing method proceeds to a step S140, in which display content matched with the content feature is determined based on the content feature.

Particularly, first, a point of interest of the user intended to browse the original web page may be determined based on the content feature. More particularly, the user's point of interest may be mined through a machine learning method or the like, based on the content feature, the detailed processes of which are known to those skilled in the art, and will not be described here in detail.

Next, the display content matched with the point of interest may be determined from a content library. That is, the content library may store display content in various aspects in advance, so that the display content in a specific aspect which is matched with the point of interest may be determined from the content library.

Taking the advertising as an example, the content library may be, such as an advertisement library of the apparatus itself (e.g., a server) to which the information processing method is applied, a third party advertisement transaction platform, or the like, in which advertisement material in various aspects, such as food, sports, travel or the like, are stored. After determining the user's current point of interest based on the web page desired to be browsed by the user currently through the processes of the steps S110-S130 as described above, the corresponding advertisement material is determined from the advertisement library or the third party advertisement transaction platform, to be advertised purposely.

Then, at a step S150, the display content is inserted into a target region corresponding to the target image, of the original web page, to obtain the target web page.

Particularly, the target region may be a region which is most suitable to insert the display content (e.g., the advertisement) in the region where the target image is located. In a first example, a specific location (e.g., a middle region, a certain corner or the like) in the region where the target image is located, may be set as the target region. In a second example, the target region may be set in a more intelligent way, so that it is associated with the content of the target image. For example, the target region may be set as a region corresponding to an image element with a relatively large area in relatively the same color among the target image. Particularly, an image segmentation process or a significant region detection process may be performed on the target image, to determine a region in the target image as the target region, the region being most suitable for inserting the display content.

Further, in such step, a display attribute of the display content may be adjusted according to a property of the target region, and the adjusted display content is adjusted into the target region. Particularly, the property of the target region include, but not limited to, at least one of a size, a shape, a color, an object attribute of the target region or the like, or any combination thereof, for example. Thereby, the display of the display content and the target image may be more harmonious.

Finally, at a step S160, the target web page is output. In an example, the information processing method according to the embodiment of the present disclosure may be applied to a server for example. The server is communicated with a user terminal such as a mobile phone, a computer or the like. Thereby, the server transmits the target web page to the user terminal, so as to be displayed on the user terminal. Alternatively, the information processing method may also be applied to the user terminal when the processing capability of the user terminal is strong. Thereby, in such step, the user terminal displays the target web page directly.

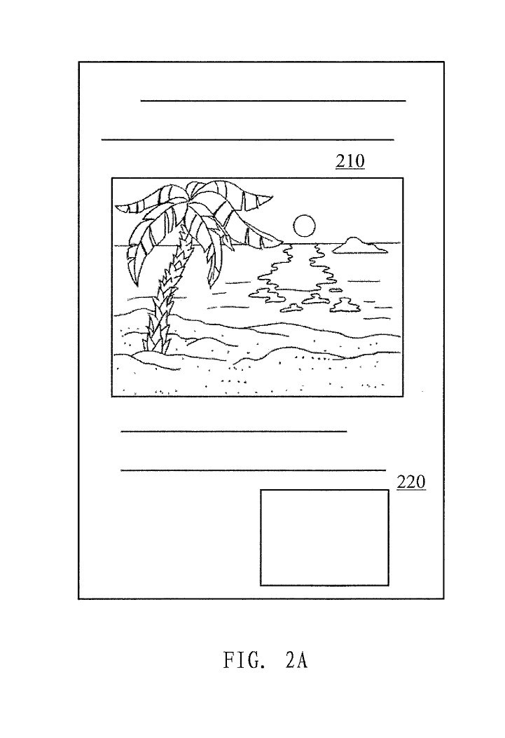

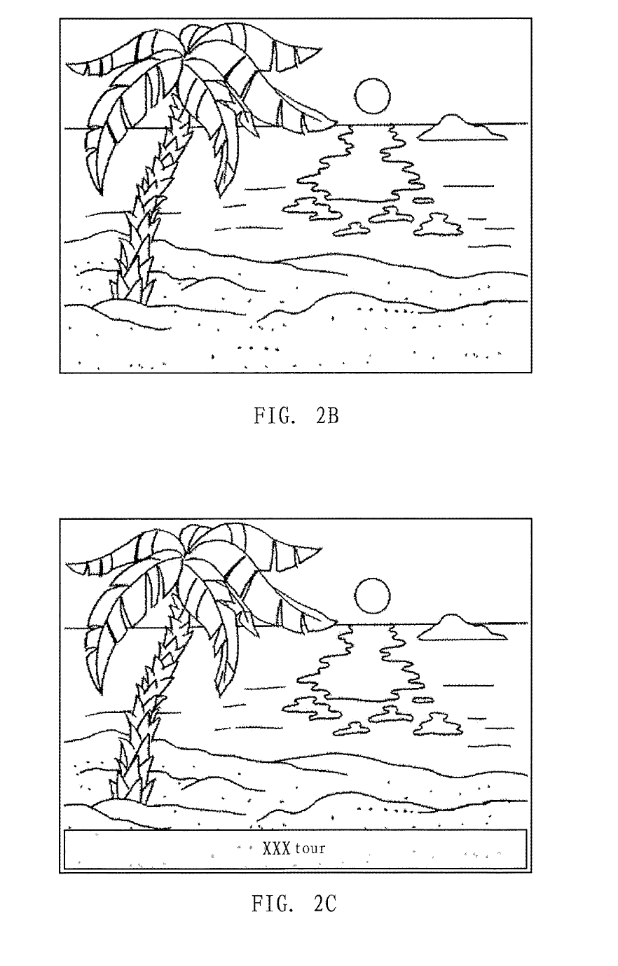

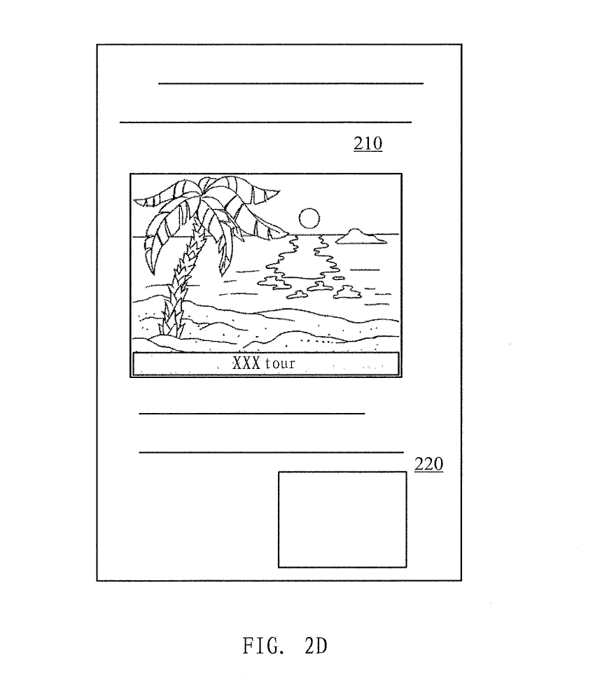

Hereinafter, assuming that the display content is an advertisement, and the schematic application scenario to which the information processing method according to the embodiment of the present disclosure is applied will be described with reference to FIG. 2.

FIG. 2A shows an original web page that is to be displayed originally according to the access request from the user, which includes two images, a first image 210 and a second image 220. It may be known by resolving the code of the original web page that, the first image 210 is located in the middle of the web page and the size of the image is larger than a threshold, while the second image 220 is located in the corner of the web page and the size of the image is smaller than the threshold. Thereby, the first image 210 is determined as the target image.

FIG. 2B shows the enlarged target image. Through an image recognition on the target image, it is recognized that the target image is a beach view, and the user's point of interest is travelling, thereby the display content matched with the beach is determined, for example, a travel agency advertisement for an island tour, so that the material image including an advertisement slogan is obtained. Then, it is analyzed that there is the image element with a relatively large area in a relatively single color at the bottom of the target image, which is schematically shown as the sand beach, thereby the region where the image element is located is determined as the target region. Next, the display attribute of the display content may be adjusted according to the property of the target region. For example, the size of the material image may be adjusted according to the size of the target region. The color of the material image may be adjusted according to the color (pale yellow) of the target region, so that the color and the shape are in harmony with the target region. Then, the adjusted advertisement material image is inserted into the target region in a form of a dialog box, for example, as shown in FIG. 2C Finally, the target web page is output, and is displayed on the user terminal as shown in FIG. 2D.

The information processing method according to the embodiment of the present disclosure has been described above with reference to FIGS. 1 and 2.

It is to be noted that although the information processing method according to the embodiment of the present disclosure is described above with the advertisement as an example, the present disclosure is not limited thereto, and may be applied to the display of various display content.

In the information processing method according to the embodiment of the present disclosure, at least one of the image and the context in the web page is analyzed to obtain the content feature of the web page, and the display content matched with the content feature is inserted into the target region of the web page, so that the information matched with the content feature of the current web page may be inserted into the web page notably without affecting the user's browsing experience.

When the information processing method according to the embodiment of the present disclosure is applied to the advertising field, the advertisement associated with the image/text of the current web page may be advertised. Particularly, the point which may be interesting to the user currently may be mined accurately based on the current web page, and the corresponding advertisement may be recommended in real time.

Further, in information processing method according to the embodiment of the present disclosure, the advertisement may be presented in an image based way, that is, may be inserted into the region where the specific image is located, in the current web page. Therefore, it is significant and the user's browsing experience on the web page wouldn't be affected. In addition, such presentation way won't need additional advertisement region, which is especially advantageous when the size of the screen is limited such as when applied to the display on the mobile phone.

Further, in the information processing method according to the embodiment of the present disclosure, the display region and its display attribute of the advertisement material may be determined according to the property of the target image, therefore, the advertisement may be presented in a more artistic and harmonious way.

Further, in the information processing method according to the embodiment of the present disclosure, the content feature of the web page is obtained through an algorithm such as a machine learning algorithm or the like and the user's point of interest is mined automatically, and the target region is determined automatically through a process such as the image segmentation process or the significant region detection process or the like. In the above processes, no manual notation is required, thereby, the processing efficiency is improved and the processing time is shortened.

The information processing apparatus according to the embodiment of the present disclosure will be described hereinafter with reference to FIG. 3.

FIG. 3 is a block diagram showing a main configuration of the information processing apparatus according to the embodiment of the present disclosure. As shown in FIG. 3, the information processing apparatus 300 according to the embodiment of the present disclosure comprises an acquiring unit 310, a resolving unit 320, an analyzing unit 330, a determining unit 340, an inserting unit 350 and an output unit 360.

Particularly, the acquiring unit 310 is operative to acquire an original web page. The resolving unit 320 is operative to resolve the original web page to determine a target image. The analyzing unit 330 is operative to analyze at least one of the target image and context associated with the target image, to obtain a content feature of the original web page. The determining unit 340 is operative to determine display content matched with the content feature based on the content feature. The inserting unit 350 is operative to insert the display content into a target region corresponding to the target image, of the original web page, to obtain a target web page. The output unit 360 is operative to output the target web page.

In an embodiment, the resolving unit 320 comprises: an image information acquiring unit operative to resolve code of the original web page to acquire image information of each image in the original web page, the image information including at least one of a size of the image, a location of the image, and a significance of the image; and a target image determining unit operative to determine the target image from all images in the original web page, based on the image information.

In another embodiment, the content feature of the original web page includes at least one of an image content feature and a context content feature, and the analyzing unit 330 comprises at least one of: an image recognition unit operative to perform an image recognition process on the target image to obtain the image content feature; a natural language processing unit operative to perform a natural language process on the context associated with the target image to obtain the context content feature.

In a further embodiment, the determining unit 340 comprises: a point of interest determining unit operative to determine a point of interest of a user intended to browse the original web page based on the content feature; and a match content determining unit operative to determine the display content matched with the point of interest, from a content library.

In a further embodiment, the inserting unit 350 comprises: an attribute adjusting unit operative to adjust a display attribute of the display content according to a property of the target region; and a content inserting unit operative to insert the adjusted display content into the target region.

In a further embodiment, the inserting unit 350 comprises: a target region determining unit operative to perform an image segmentation process or a significant region detection process on the target image, to determine a region in the target image as the target region, the region being most suitable for inserting the display content; and a content inserting unit operative to insert the display content into the target region.

The functions and the configurations of the individual units of the information processing apparatus 300 have been described in detail in the information processing method with reference to FIG. 1, and will not be repeated here.

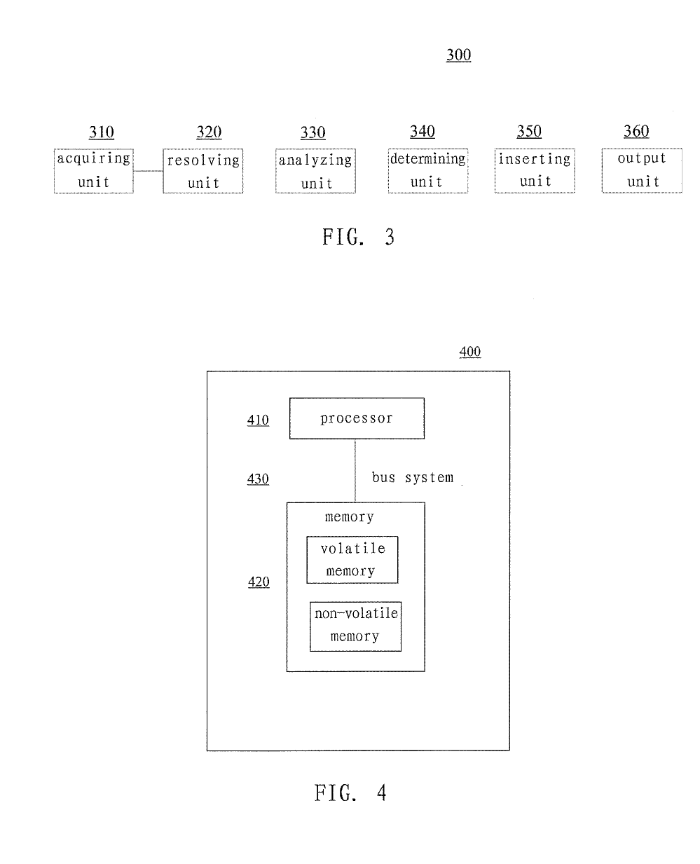

FIG. 4 is a block diagram showing a main configuration of the information processing apparatus according to another embodiment of the present disclosure.

As shown in FIG. 4, the information processing apparatus 400 according to the embodiment of the present disclosure mainly includes one or more processor(s) 410 and one or more memory (memories) 420. These components are interconnected with each other through a bus system 430 and/or a connection mechanism in other forms (not shown). It should be noted that the components and the structure of the information processing apparatus 400 as shown in FIG. 4 are only exemplarily but not limiting, and the information processing apparatus 400 may comprise other components with other structures when necessary.

The processor 410 may be a Central Processing Unit (CPU) or a processing unit in other forms having a data processing capability and/or an instruction execution capability, and may control other components in the information processing apparatus 400 to perform a desired function.

The memory 420 may include one or more computer program product(s) which may include computer readable storage media in various forms, for example, a volatile memory and/or a non-volatile memory. The volatile memory may, for example, include a Random Access Memory (RAM) and/or a cache memory (cache) or the like. The non-volatile memory may, for example, include a Read Only Memory (ROM), a hard disk, a flash memory or the like. There may be one or more computer program instructions stored on the computer readable storage media, which may be executed by the processor 410 so as to implement respective functions and/or other desired functions of the information processing method of an embodiment of the present disclosure as described hereinbefore.

The information processing apparatus according to the embodiment of the present disclosure have been described above with reference to FIGS. 3 and 4.

In the information processing apparatuses according to the embodiment of the present disclosure, at least one of the image and the context in the web page is analyzed to obtain the content feature of the web page, and the display content matched with the content feature is inserted into the target region of the web page, so that the information matched with the content feature of the current web page may be inserted into the web page notably without affecting the user's browsing experience.

When the information processing apparatuses according to the embodiment of the present disclosure is applied to the advertising field, the advertisement associated with the image/text of the current web page may be advertised. Particularly, the point which may be interesting to the user currently may be mined accurately based on the current web page, and the corresponding advertisement may be recommended in real time.

Further, in information processing apparatuses according to the embodiment of the present disclosure, the advertisement may be presented in an image based way, that is, may be inserted into the region where the specific image is located, in the current web page. Therefore, it is significant and the user's browsing experience on the web page wouldn't be affected. In addition, such presentation way won't need additional advertisement region, which is especially advantageous when the size of the screen is limited such as when applied to the display on the mobile phone.

Further, in the information processing apparatuses according to the embodiment of the present disclosure, the display region and its display attribute of the advertisement material may be determined according to the property of the target image, therefore, the advertisement may be presented in a more artistic and harmonious way.

Further, in the information processing apparatuses according to the embodiment of the present disclosure, the content feature of the web page is obtained through an algorithm such as a machine learning algorithm or the like and the user's point of interest is mined automatically, and the target region is determined automatically through a process such as the image segmentation process or a significant region detection process or the like. In the above processes, no manual notation is required, thereby, the processing efficiency is improved and the processing time is shortened.

Further, according to another embodiment of the present disclosure, there is further provided a computer program product for information processing. The computer program product includes a computer readable storage medium having stored thereon one or more computer program instruction(s), which may be executed by a processor to cause the processor to perform the processes of: acquiring an original web page; resolving the original web page to determine a target image; analyzing at least one of the target image and context associated with the target image, to obtain a content feature of the original web page; determining display content matched with the content feature based on the content feature; inserting the display content into a target region corresponding to the target image, of the original web page, to obtain a target web page; and outputting the target web page.

It is to be noted that in the specification, the terms comprising, containing or any other variation are intended to be inclusive non-exhaustively, so that a process, a method, a product or a device comprising a series of elements not only include those elements, but may also include other elements not listed explicitly, or include elements inherent to the process, the method, the product or the device. Without any other limitation, an element limited by a expression “comprising a” does not exclude other same elements included in the process, the method, the product or the device comprising the element.

Further, it is to be noted that in the specification, the expressions similar to a first . . . unit, a second . . . unit are only for distinction, and do not mean that they must be realized as two or more units. In fact, the units may be realized as one single unit or multiple units as necessary.

Finally, it is to be noted that the above series process not only include the processes performed in a time order, but may also include processes in parallel or individually other than in the time order.

From the description of the embodiments, those skilled in the art may understand clearly that the present disclosure may be realized by software in combination with necessary hardware platform, and of course may all be implemented by hardware. Base on such understanding, the part of the technical solution of the invention which is contribute to the prior art may be embodied in the form of software product. This computer software product can be stored in a storage medium, such as a ROM/RAM, a disk, an optical disc and the like, include many instructions to cause one computer device (may be personal computer, server or network device etc.) to implement the embodiments of the invention or method describe by some parts of the embodiment.

In the embodiment of the present disclosure, the module may be realized by software so as to be executed by various processors. For example, an identified executable code module may comprise one or more physical or logical units of the computer instructions, which may, for example, be constructed as an object, a process or a function. Nevertheless, the executable codes of the identified module are not necessary to be located together physically, and may comprise different instructions stored at different locations, which may construct a module and achieve the predetermined purpose of the module when being combined together logically.

When the module is realized by software, considering the existing hardware manufacture process, those skilled in the art may realize its function by corresponding hardware circuits comprising the normal VLSI circuit or the existing semiconductor such as a logical chip or a transistor, or other separate elements, without the consideration of cost. The module may also be realized by a programmable hardware device, such as a field programmable gate array, a programmable array logic, or a programmable logical device, etc.

The above is only embodiments of the present disclosure. It should be noted that various modifications and alternations may be made by those of ordinary skill in the art without departing from the principle of the present disclosure, which should also be viewed as falling within the protection scope of the present disclosure.

What is claimed is:

1. An information processing method, comprising:
acquiring an original web page;
resolving the original web page to determine a target image;
analyzing at least one of the target image and context associated with the target image, to obtain a content feature of the original web page;
determining display content matched with the content feature based on the content feature;
inserting the display content into a target region corresponding to the target image, of the original web page, to obtain a target web page; and
outputting the target web page.

2. The information processing method of claim 1, the step of resolving the original web page comprising:
resolving code of the original web page to acquire image information of each image in the original web page, the image information including at least one of the size of the image, the location of the image, and the significance of the image; and
determining the target image from all images in the original web page, based on the image information.

3. The information processing method of claim 1, wherein, the content feature of the original web page includes at least one of an image content feature and a context content feature, and the step of analyzing at least one of the target image and the context associated with the target image comprises at least one of:
performing an image recognition process on the target image to obtain the image content feature;
performing a natural language process on the context associated with the target image to obtain the context content feature.

4. The information processing method of claim 1, the step of determining display content matched with the content feature comprising:
determining an point of interest of a user intended to browse the original web page, based on the content feature; and
determining the display content matched with the point of interest, from a content library.

5. The information processing method of claim 1, the step of inserting the display content into the target region corresponding to the target image, of the original web page comprising:
adjusting a display attribute of the display content according to a property of the target region; and
inserting the adjusted display content into the target region.

6. The information processing method of claim 1, the step of inserting the display content into the target region corresponding to the target image, of the original web page comprising:
performing an image segmentation process or a significant region detection process on the target image, to determine a region most suitable for inserting the display content in the target image as the target region; and
inserting the display content into the target region.

7. An information processing apparatus, comprising:
a processor;
a memory;
computer program instructions stored in the memory, which, when executed by the processor, perform steps of:
acquiring an original web page;
resolving the original web page to determine a target image;
analyzing at least one of the target image and context associated with the target image, to obtain a content feature of the original web page;
determining display content matched with the content feature based on the content feature;
inserting the display content into a target region corresponding to the target image, of the original web page, to obtain a target web page; and
outputting the target web page.

8. The information processing apparatus of claim 7, the step of resolving the original web page to determine the target image comprising:
resolving code of the original web page to acquire image information of each image in the original web page, the image information including at least one of the size of the image, the location of the image, and the significance of the image; and
determining the target image from all images in the original web page, based on the image information.

9. The information processing apparatus of claim 7, wherein, the content feature of the original web page includes at least one of an image content feature and a context content feature, and the step of analyzing at least one of the target image and the context associated with the target image comprises at least one of:
performing an image recognition process on the target image to obtain the image content feature;
performing a natural language process on the context associated with the target image to obtain the context content feature.

10. The information processing apparatus of claim 7, the step of determining display content matched with the content feature based on the content feature comprising:
determining a point of interest of a user intended to browse the original web page, based on the content feature; and
determining the display content matched with the point of interest, from a content library.

11. The information processing apparatus of claim 7, the step of inserting the display content into a target region corresponding to the target image, of the original web page, to obtain a target web page comprising:
adjusting a display attribute of the display content according to a property of the target region; and
inserting the adjusted display content into the target region.

12. The information processing apparatus of claim 7, the step of inserting the display content into a target region corresponding to the target image, of the original web page, to obtain a target web page comprising:
performing an image segmentation process or a significant region detection process on the target image, to determine a region most suitable for inserting the display content in the target image as the target region; and
inserting the display content into the target region.

13. A computer program product comprising a computer readable storage medium having stored thereon computer program instructions, which, when executed by a computer, perform the steps of the information processing method of claim 1.
